(19) United States
(12) Patent Application Publication
(10) Pub. No.: US 2008/0202561 A1
(43) Pub. Date: Aug. 28, 2008

(54) Methods and Compositions for Reducing Deposits In Engines Combusting Alcohol-Containing Fuels

(76) Inventors: Richard J. DuMont, Richmond, VA (US); Alexander M. Kulinowski, Mechanicsville, VA (US); Lawrence J. Cunningham, Mechanicsville, VA (US)

Correspondence Address: AFTON CHEMICAL CORPORATION;LUEDEKA, NEELY & GRAHAM, PC, P.O. BOX 1871, KNOXVILLE, TN, 37901, US

(21) Appl. No.: 11/681,020

(22) Filed: Mar. 1, 2007

Related U.S. Application Data
(60) Provisional application No. 60/891,172, filed on Feb. 22, 2007.

(51) Int. Cl. B08B 7/00

(52) U.S. Cl. 134/20; 44/451; 510/185

(57) ABSTRACT

The present disclosure provides compositions and methods for reducing deposit formation in engines combusting a fuel containing ethanol and a corrosion inhibitor. The present disclosure also provides compositions and methods for reducing deposit formation in engines combusting a fuel containing ethanol, a corrosion inhibitor, and a dispersant.

### RELATED APPLICATIONS

This application claims the benefit of priority of U.S. Provisional Application No. 60/891,172, filed on Feb. 22, 2007.

### FIELD

The present disclosure relates to the use of a dispersant fuel additive in fuels containing an alcohol and a corrosion inhibitor. The dispersant fuel additives improve the properties of the resulting fuel and also enhance the benefits to the consumer and to the environment of utilizing varying amounts of ethanol as a fuel in combustion engines. Further, the present disclosure relates to the use of a dodecenyl succinic acid (DDSA) corrosion inhibitor in fuels containing an alcohol. In particular, the present disclosure provides compositions and methods for reducing the formation of deposits in engines combusting a fuel containing an alcohol, such as ethanol, and a corrosion inhibitor.

### BACKGROUND

The use of ethanol alone or in gasoline blends can create new problems for fuel equipment designed to handle the more non-polar hydrocarbonaceous petroleum fractions commonly known as gasolines. The polarity, corrosivity, adhesiveness, friction properties, and perhaps conductivity of ethanol or ethanol-containing fuel can create new problems and new needs in the fuel industry.

A common blend of gasoline and ethanol being discussed is 15% gasoline and 85% ethanol, often commonly referred to as “E85” fuel (hereinafter “E85”). Other ethanol fuels can comprise, for example 10% ethanol (E10) and 100% ethanol (E100).

Commercial ethanol is widely treated with additives designed to prevent human consumption. Such treated ethanol is called denatured alcohol (or denatured ethanol) and common denaturants include gasoline, gasoline components, and kerosene. Other denaturants for rendering fuel alcohol unfit for beverage use are defined in 27 CFR 21.24.

The use of varying degrees of ethanol in gasoline fuels can create problems with, for example, increased engine deposits, fuel stability, corrosion, fuel economy, fuel driveability, luminosity, fuel economy, demulse, ignition, driveability, antioxidancy, oil drain interval, achieving CARB standards, achieving Top-Tier auto-maker standards, achieving US EPA standards, solubility, component compatibility, fuel line plugging, engine durability, engine wear, and injector fouling, which will benefit from the inclusion in the fuel of certain fuel additives.

Work by the auto manufacturers and others has indicated that low pHe ethanol (in both E-85 and E-10 blends) can contribute to accelerated corrosion of certain fuel system parts. While the ASTM Standards limit total acidity, as acetic acid, to 0.007 mass percent (56 mg/L), this standard is not always sufficient to limit more aggressive sulfuric based acids. Ethanol meeting the ASTM acidity standard may still be of low pHe. This accelerated corrosion has prompted the use of corrosion inhibitors to buffer the ethanol and protect metal components of the fuel distribution system; however, these can cause the formation of undesirable engine deposits. Therefore, a buffer is often desired.

DCI-11 is a commercially available corrosion inhibitor and buffer sold by Innospec (formerly Associated Octel) and used in fuels. However, engine deposit problems arise from the combustion of ethanol-containing fuels containing this and other corrosion inhibitors. These deposits differ significantly from conventional deposits that result from fuel and lubricant degredation and/or combustion.

A need therefore exists for a solution to the problem of these new and unexpected engine deposits formed in engines combusting ethanol-containing fuels having corrosion inhibitors or gasoline-ethanol-corrosion inhibitor mixtures. A need also exists to retain DCI-11 to buffer the acidic species such as acetic acid and/or sulfuric based acids, among others, present in ethenol-containing fuels, but overcome the new and unexpected deposit formations.

### SUMMARY OF THE EMBODIMENTS

An embodiment presented herein provides fuel additive agents for use in reducing or inhibiting corrosion inhibitor-derived deposits in engines (or engine components) combusting ethanol-containing fuels, including but not limited to E100, E85, E50, and the like down to E10 and trace blends of ethanol in gasoline.

Another embodiment presented herein provides a dispersant fuel additive agent for use in reducing or inhibiting deposits in engines (or engine components) combusting a corrosion inhibitor and ethanol-containing fuels, including but not limited to E100, E85, E50, and the like down to E10 and trace blends of ethanol in gasoline. Suitable dispersant fuel additives include succinimide dispersants, succinamide dispersants, amides, Mannich base dispertants, polyalkylene amine dispersants, and polyisobutylene amine dispersants.

In another embodiment, it has been observed that the dispersants or mixtures thereof are very effective in reducing or preventing the formation of engine deposits formed in an engine combusting an ethanol-containing fuel that further contains combinations of at least one organinc acid and at least one amine or their salts useful as corrosion inhibitors.

In one embodiment herein, the ethanol content of the fuel composition is from about 74 to about 85%. In another embodiment, the fuel is 100% ethanol and in yet another embodiment the ethanol content of the fuel composition is about 50%, or is from about 50% to about 74%.

Another embodiment provides a method to improve corrosion inhibition and/or to reduce the formation of engine deposits in an internal combustion engine, said method comprising combusting in said engine a fuel composition comprising gasoline, ethanol and at least one dispersant fuel additive. The dispersant fuel additives used herein are effective in preventing or minimizing corrosion of and/or deposits on metal surfaces and certain plastic or synthetic parts or surfaces in combustion engines that come in contact with fuel containing ethanol and a corrosion inhibitor. Parts such as fuel pumps, valves, gaskets, float devices, relay or signaling devices, gauges, screens, filters, intake valves, pistons, and others can all experience some degree of corrosion and/or deposits. The corrosion and/or deposits can vary depending on the type and duration of exposure, the chemical nature of the exposed surface, and the concentration of ethanol and corrosion inhibitor in the fuel. By the present disclosure, a fuel additive package or concentrate for ethanol-containing fuel can be designed to reduce corrosion and deposit formation in these engines. The fuel additive concentrate herein can contain one or more corrosion inhibitors, a dispersant, and a diluent which can be an oil, a fuel, gasoline, ethanol, solvent, carrier fluid, or other material combustible in a gasoline engine.

There is provided herein a fuel additive package or concentrate for ethanol-containing fuel, said concentrate comprising one or more corrosion inhibitors set forth herein and a diluent which can be an oil, a fuel, gasoline, ethanol, solvent, carrier fluid, or other liquid material combustible in a gasoline engine.

Thus, in one embodiment herein is provided a fuel additive concentrate comprising ethanol and a dispersant, for use in a gasoline containing a corrosion inhibitor as defined herein, including but not limited to those materials having a product resulting from combining an organic acid or diacid and an amine, diamine, or polyamine.

Accordingly, in another example herein is provided a composition to reduce corrosion and/or corrosion inhibitor-induced deposits in an internal combustion engine combusting an ethanol-containing fuel, said composition comprising gasoline, ethanol, and one or more materials selected from the group consisting of succinimide dispersants, succinamide dispersants, amides, Mannich base dispersants, polyalkylene amine dispersants, and polyisobutylene amine dispersants.

In another embodiment, a method for reducing deposit formation in an internal combustion engine combusting an alcohol-containing fuel composition may comprise combining the fuel with a dodecenyl succinic acid (DDSA) corrosion inhibitor and combusting the fuel and the DDSA corrosion inhibitor in the engine. The deposit formation may be reduced relative to the deposit formation occurring when combusting the alcohol-containing fuel composition with a corrosion inhibitor substantially free of a DDSA corrosion inhibitor.

In another embodiment, a composition to reduce deposit formation in an internal combustion engine combusting an alcohol-containing fuel may comprise a DDSA corrosion inhibitor and an alcohol.

In another embodiment, a fuel may comprise one or more alcohols, a gasoline, and a DDSA corrosion inhibitor.

It is to be understood that both the foregoing general description and the following detailed description are exemplary and explanatory only and are intended to provide further explanation of the present disclosure, as claimed.

### DETAILED DESCRIPTION OF EMBODIMENTS

By “corrosion” herein is meant any degradation, rusting, weakening, deterioration, softening, and the like of an engine surface or a part or component of an engine or an engine component or part due to exposure to an ethanol-containing fuel.

By “PEA” and “polyetheramine” herein is meant organic compounds having one or more aminic nitrogen atoms, and one or more oxygen-containing ether bonds. Thus, the prefix “poly-” is not a limitation here requiring two or more but rather is the common term of art and can, in one embodiment, encompass an organic compound having one aminic nitrogen, and one oxygen-containing ether bond if the molecular weight and solubility prevent deposit formation. The ether portions can be derived from, for example, ethylene oxide, propylene oxide, butylene oxide and mixtures thereof. In a particular embodiment, the PEA can be a diamine, and/or can have a molecular weight of greater than 700. In another embodiment, the molecular weight of the polyetheramine can be 700 to 3000 and particularly 900 to 1500. More specifically, PEA's useful in the present disclosure can also include carbamates, amino carbamates, mono- and di-thiocarbamates, amino alkyls, and amido alkanolamines, all of which are known to those skilled in the art. A key to the performance in the present disclosure is the need for solubility of the detergent in the ethanol-containing fuel requires more polarity than present with conventional (non-polar) polyisobutylene detergents.

By “corrosion inhibition” or “reducing corrosion” herein is meant any improvement in minimizing, reducing, eliminating or preventing corrosion.

By “deposits” or “engine deposits” herein is meant build up of solid material within an engine, where the deposits can originate from the fuel before combustion, uncombusted fuel, and combustion by-products, or from corrosion inhibitors added to ethanol or to ethanol-gasoline blends. The deposits can also include material on the intake valves (known as Intake Valve Deposits or IVD) or combustion chamber deposits (known as CCD), or fuel injector deposits. The “deposits” herein can appear in or on metal surfaces and certain plastic or synthetic parts or surfaces in combustion engines that come in contact with fuel containing ethanol and a corrosion inhibitor. Parts such as fuel pumps, valves, gaskets, float devices, relay or signaling devices, gauges, screens, filters, intake valves, combustion chambers, port injectors, pistons, and others experience some degree of deposits from the corrosion inhibitors described in ethanol fuels.

By “ethanol” herein is meant ethyl alcohol, the chemical compound C₂H₅OH. This can arise in or be provided in many qualities or grades, such as commercial or fuel grade, as well as pure or reagent grade ethanol, and can be derived from any source such as but not limited to petroleum refinery streams, distillation cuts, and bio-derived (e.g. bioethanol from corn or other crops). In some embodiments, ethanol may be present in an amount of from about 10 to about 100 wt % based on the total fuel composition. In another embodiment, the ethanol may be present in an amount of from about 15 to about 85 wt % based on the total fuel composition. In an even further embodiment, the ethanol may be present in an amount of from about 74 to about 85 wt % based on the total fuel composition.

By “New Energy ethanol” herein is meant ethanol produced by or for a company known as New Energy and which ethanol is known to have about 0.9 PTB or less of Innospec DCI-11 corrosion inhibitor.

By “ADM ethanol” herein is meant ethanol produced by or for Archer Daniels Midland Corporation and which is known to have about 32 PTB of Innospec DCI-11 corrosion inhibitor.

By “corrosion inhibitor” herein is meant at least the following: low molecular weight (i.e., <700) amines (mono-, di-, tri, and poly), amines, etheramines, imines, imidazolines, thiadiazoles, mocarboxylic acids, dicarboxylic acids, p-phenylenediamine and dicyclohexylamine, alkyl substituted succinic anhydrides and acids and mixtures thereof and salts thereof. Corrosion inhibitors useful herein can also include or comprise tetrapropenylsuccinic acid or anhydride and polymers thereof. These can include the commercial products, for example, those known as Petrolite Tolad 3222 and Petrolite Tolad 3224 which are believed to be generally of a structure NH₂(CH₂)ₙ—NH—(CH₂)ₘO—C₈₋₁₀ where n and m are independently 1 to about 10. Also included herein as “corrosion inhibitor” is the Innospec (formerly Associated Octel) product DCI-11™, which is believed to contain the reaction product of an organic acid and an amine or a diamine, such as Duomine™ having the structure NH_{2(CH}₂)ₙ—NH—C₈₋₁₀ where n is 1 to about 10. The DCI-11 product is believed to be the low molecular weight (<500) amine salt of a carboxylic acid. Another suitable corrosion inhibitor is dodecenyl succinic acid (DDSA).

By “dispersant,” “dispersant additive,” or “dispersant fuel additive” herein is meant a dispersant, a dispersant-detergent, or a dispersant composition that contains two or more dispersants of the same or different type. Suitable dispersants include, but are not limited to succinimide dispersants, succinamide dispersants, amides, Mannich base dispersants, polyalkylene amine dispersants, and polyisobutylene amine dispersants.

A fuel additive suitable for use in compositions disclosed herein may also comprise one or more of a phenolic; a hindered phenolic; a polyolefin amine; an aryl amine; a diphenyl amine; a monocarboxylic acid; a dicarboxylic acid; a polycarboxylic acid; an oxylated alkylphenolic resin; a formaldehyde polymer with 4-(1,1-dimethylethyl)phenol, a methyloxirane, and oxirane; an octane enhancer material selected from the group consisting of tetraethyl lead, methylcyclopentadienyl manganese tricarbonyl, an azide, a peroxide, and an alkyl nitrate; a monoester; a diester; an ether; a ketone; a diether; a polyether; a glyme; a glycol; an oxirane; a C1-C8 aliphatic hydrocarbon; a butylene oxide; a propylene oxide; an ethylene oxide; an epoxide; a butane; a pentane; a xylene; a nitrous oxide; a nitromethane; a phenate; a salicylate; a sulfonate; a nonylphenol ethoxylate; a fuel-soluble alkali detergent; and an alkaline earth metal-containing detergent.

Petrolite Tolad 357 is a corrosion inhibitor useful herein and believed to be a composition having a molecular weight of about 700 or less comprising (1) an alkenyl succinic acid or anhydride (ASAA), and (2) the reaction product of ASAA and a trialkanol amine such as triethanolamine (TEA) where ASAA (3 moles) is reacted with TEA (1 mole) to yield an amide and/or an amine salt.

In another embodiment the corrosion inhibitor is the product of combining an organic acid or diacid and an amine, diamine, or polyamine in a ratio of about 5:1

In another embodiment herein is provided a fuel composition that can be, or can comprise, 1.0 to 100 volume percent of one or more alcohols, and 0 to 99% gasoline, and a corrosion inhibitor, said inhibitor comprising, by weight, (a) about 35% to 70% of at least one mono- or di-alkenyl succinic acid in which the alkenyl group has 8 to 18 carbons; and (b) about 30% to 65% of an aliphatic or cycloaliphatic amine, diamine or polyamine containing 2 to 12 carbon atoms. In one embodiment, the corrosion inhibitor can be dissolved in a hydrocarbon solvent consisting of an aromatic hydrocarbon, an alcohol containing 1 to 4 carbon atoms, or mixture thereof, the ratio of the hydrocarbon solvent to the total of (a) and (b) being about 15:85 to 50:50, wherein the corrosion inhibitor is present in the fuel composition at less than about 1000 ppm.

In another embodiment herein the corrosion inhibitor can be or comprise a composition having by weight (a) about 75% to 95% of at least one polymerized unsaturated aliphatic monocarboxylic acid, said unsaturated acid having 16 to 18 carbons per molecule, and (b) about 5% to 25% of at least one monoalkenylsuccinic acid in which the alkenyl group has 8 to 18 carbons.

In another embodiment the corrosion inhibitor may comprise a dodecenyl succinic acid (DDSA).

The corrosion inhibitor can be blended into or with the ethanol, or the gasoline, or the ethanol/gasoline blend.

Corrosion inhibitors herein can include, but are not limited to, the following commercial products and their derivatives and chemically equivalent products:

Octel DCI-11 often used in fuel ethanol at, for example, about 20 PTB

Petrolite Tolad 3222 often used in fuel ethanol at, for example, about 20 PTB

Petrolite Tolad 3224 often used in fuel ethanol at, for example, about 13 PTB

Petrolite Tolad 357 often used in fuel ethanol at, for example, about 15 PTB

Nalco 5403 often used in fuel ethanol at, for example, about 30 PTB

ENDCOR FE-9730 (formerly Betz® ACN 13) often used in fuel ethanol at, for example, about 20 PTB

MidContinental MCC5011E often used in fuel ethanol at, for example, about 20 PTB

MidContinental MCC5011EW often used in fuel ethanol at, for example, about 27 PTB

CorrPro 654 often used in fuel ethanol at, for example, about 13 PTB

Afton Chemical's HiTEC® 6455 at, for example, about 32 PTB

By “PTB” herein is meant “pounds per thousand barrels” a common term of art in the fuel additive industry. A PTB is roughly equivalent to about 4 ppm.

Thus, there is provided herein in one embodiment a method to reduce deposits formed in an internal combustion engine, said method comprising combusting in said engine a fuel composition comprising gasoline, alcohol, a corrosion inhibitor and at least one dispersant fuel additive, whereby deposits in the engine are prevented or reduced relative to the deposits produced in the engine when combusting an alcohol-containing fuel composition containing a corrosion inhibitor but without at least one dispersant fuel additive. In one embodiment herein the alcohol is ethanol and in another it is methanol, propanol, butanol, and/or mixtures comprising any combination thereof.

It has also been discovered that excess acidic components, such as acetic acid and sulfuric acidic species, contribute to wear and deposit accumulation in the engines and/or on the valves or other engine parts. The use herein of a dispersant helps to raise the pH slightly by buffering the acetic and/or sulfuric acid components, thereby reducing or preventing the formation of deposit-contributing reaction products. The use of dispersant herein is also useful in buffering the acid corrosion inhibitor. Thus, the present disclosure provides a corrosion inhibitor buffer in the form of a dispersant used in ethanol-containing fuels.

Also provided herein is a fuel comprising (a) an alcohol selected from the group consisting of methanol, ethanol, propanol, and butanol, and mixtures thereof, (b) gasoline, (c) the product of combining an organic carboxylic acid or diacid and an amine, diamine, or polyamine and (d) a dispersant comprising one or more of a succinimide dispersant, a succinamide dispersant, an amide, a Mannich base dispersant, a polyalkylene amine dispersant, and a polyisobutylene amine dispersant.

It has also been found that utilizing a dodecenyl succinic acid (DDSA) corrosion inhibitor decreases the deposit formation in an internal combustion engine. In one embodiment, DDSA is suitable for use in lieu of the conventional DCI-11 corrosion inhibitor. Further, in another embodiment, the DDSA corrosion inhibitor may be used with or without a dispersant fuel additive.

The following examples further illustrate aspects of the present disclosure but do not limit the present disclosure.

### EXAMPLES

Test Method—Chevrolet Impala FFV test—5000 mile intake valve deposit test run on a 2006 3.5 liter 6-cylinder Flexible Fuel Vehicle (FFV) Chevrolet Impala. FFV refers to vehicles capable of operating on blends of up to 85% ethanol and 15% hydrocarbon such as unleaded gasoline. The test consisted of multistage 100 minute cycles made up of a mix of accelerations and steady driving at 25 MPH, 40 MPH and 65 MPH. The engine's six intake valves are weighed before the start of mileage accumulation and at the end of the 5000 test miles. The average of the difference in intake valve deposits (IVD) is reported as the average intake valve deposit weight.

TABLE I
5,000 Mile Chevrolet Impala FFV Deposit Test Results

| | | | | | H-6560, | | | | |
|---|---|---|---|---|---|---|---|---|---|
| | | | | H-6400 | Mannich | H-6455, | | Sodium | |
| | Ethanol | | RUL | PEA, | Dispersant, | DDSA | DCI-11, | Sulfates, | Avg IVD |
| Examples | Source | Ethanol, % | gasoline, % | PTB | PTB | PTB | PTB | ppm vol. | mg/valve |
| 1 | none | 0 | 100 | 0 | | | 0 | | 429 |
| 2 | A | 84 | 16 | 0 | | | 32 | | 227 |
| 3 | B | 84 | 16 | 0 | | | 0 | | 99 |
| 4 | B | 84 | 16 | 0 | | | 32 | | 230 |
| 5 | B | 84 | 16 | | | | | 4 | 96 |
| 6 | A | 84 | 16 | 500 | | | 32 | | 4 |
| 7 | A | 84 | 16 | 85 | | | 32 | | 11 |
| 8 | A | 84 | 16 | | 85 | | 32 | | 14 |
| 9 | A | 84 | 16 | 42.5 | 42.5 | | 32 | | 16 |
| 10 | B | 84 | 16 | | | 32 | | | 81 |

In the Table, Ethanol Source A refers to ADM Denatured Ethanol containing 4 ppm sulfates and 32 PTB Innospec DCI-11 corrosion inhibitor. The 32 PTB Innospec DCI-11 is indicated in the table. No additional DCI-11 is added to Ethanol Source A in any of the examples. Ethanol Source B refers to New Energy Denatured Ethanol containing less than 1 ppm sulfates and 0.9 PTB corrosion inhibitor.

### Example 1

An additive-free conventional regular unleaded (RUL) gasoline was run for 5,000 miles in a 2006 3.5 L Flexible Fuel (FFV) Chevrolet Impala running a modified Quad 4 cycle. The 429 mg/valve deposit level is typical of what would be expected from this type of fuel and test cycle.

### Example 2

A fuel was prepared by blending 84% Ethanol Source A with 16% conventional regular unleaded gasoline. The Ethanol Source A contained 32 PTB of Innospec DCI-11 corrosion inhibitor as supplied. This is indicated in Table I. No additional DCI-11 was added to the mixture. When tested in the Chevrolet Impala FFV test, Example 2 generated a surprisingly high level of intake system deposits. Pure ethanol burns cleanly and generates very few deposits, so one would have expected Example 2 to generate less than 100 mg/valve or only 15-20% of the deposits observed with 100% gasoline since only 15%-20% of the E-85 fuel was made up of the unleaded gasoline. Instead, the Example 2 gave a surprisingly high level average IVD of 227 mg/valve, which is more than double what would have been predicted.

### Example 3

A fuel was prepared from 84% Ethanol Sample B which contained less than 1 PTB of corrosion inhibitor. When this fuel was tested in the Chevrolet Impala FFV test, it generated average intake valve deposits of 99 mg/valve. This is more of what one would expect from running the test on a blend of 84% clean burning ethanol and 16% regular unleaded gasoline.

### Example 4

This fuel was prepared by blending 84% Ethanol Sample B, which contains very little corrosion inhibitor, with 16% regular unleaded gasoline and 32 PTB of Innospec DCI-11 corrosion inhibitor. When this fuel was tested in the Chevrolet Impala FFV test, it generated essentially the same deposit level, 230 mg/valve, as the fuel tested in Example 2. These results suggest that the Innospec corrosion inhibitor DCI-11 is surprisingly contributing to the mass of the intake valve deposit.

### Example 5

This fuel was prepared by blending 84% Ethanol Sample B, which contains very little sulfates, with 16% regular unleaded gasoline and 4 ppm sodium sulfates. The resulting average IVD was 96 mg/valve which indicates that the sulfate content of Ethanol Sample A does not significantly contribute to the high average IVD in Example 2.

### Example 6

This fuel included the same composition as Example 2 plus 500 PTB of Afton Chemical's HiTEC® 6400 polyetheramine (PEA). When this fuel was tested in the Chevrolet Impala FFV test, it generated an average IVD of only 4 mg/valve of intake valve deposit, even though it contained 32 PTB of Innospec DCI-11 corrosion inhibitor as supplied.

### Example 7

This fuel included the same composition as Example 2 plus 85 PTB of HiTEC® 6400 PEA. When this fuel was tested in the Chevrolet Impala FFV test, it generated an average IVD of 11 mg/valve, even though it contained 32 PTB of Innospec DCI-11 corrosion inhibitor.

### Example 8

This fuel included the same composition as Example 2 plus 85 PTB of Afton Chemical's HiTEC® 6560 Additive Package that includes a Mannich Dispersant. When this fuel was tested in the Chevrolet Impala FFV test, it generated an average IVD of 14 mg/valve, even though it contained 32 PTB of Innospec DCI-11 corrosion inhibitor.

### Example 9

This fuel included the same composition as Example 2 plus 85 PTB of Afton Chemical's HiTEC® 6560 Additive Package that includes a Mannich Dispersant. When this fuel was tested in the Chevrolet Impala FFV test, it generated an average IVD of 14 mg/valve, even though it contained 32 PTB of Innospec DCI-11 corrosion inhibitor.

### Example 10

This fuel included the same composition as Example 3 plus 32 PTB of Afton Chemical's corrosion inhibitor HiTEC® 6455 dodecenyl succinic acid (DDSA). When this fuel was tested in the Chevrolet Impala FFV test, it generated an average IVD of 81 mg/valve. This result is much lower than the average IVD value of 230 mg/valve produced by the Innospec DCI-11 corrosion inhibitor in Example 4.

Normally the majority of intake valve deposits are formed from decomposition of fuel components on the intake valves and additives are designed to remove those types of deposits. These examples show that the majority of deposits formed from ethanol-gasoline fuel blends can come from the use of a corrosion inhibitor that would generate a different type of intake valve deposits. It has been discovered that dispersant additives can effectively remove conventional deposits formed from the fuel and also effectively remove deposits caused by the use of corrosion inhibitors in ethanol-gasoline fuel blends.

Table II below provides illustrations of some desired additive combinations for various ethanol-containing fuels whereby corrosion might be controlled or reduced in an engine combusting the ethanol-containing fuel.

TABLE II

| Fuel | A | B | C | D | E | F | G | H | I | J |
|---|---|---|---|---|---|---|---|---|---|---|
| E85 | 40–200 | 120 | | | | | | | | |
| E85 | 40–200 | | 80 | | | | | | | |
| E85 | 40–200 | | | 100 | | | | | | |
| E85 | 40–200 | | | | 120 | | | | | |
| E85 | 40–200 | | | | | 140 | | | | |
| E85 | 40–200 | | | | | | 160 | | | |
| E85 | 40–200 | | | | | | | 100 | | |
| E85 | 40–200 | | | | | | | | 120 | |
| E85 | 40–200 | | | | | | | | | 100 |

Where amounts are in ppm of the finished fuel:
A=HiTEC® 6400 PEA, HiTEC® 6560 Additive Package including a Mannich Dispersant, or other suitable dispersants such as a succinimide, a succinamide, a polyalkylene amine, polyisobutylene amine, and an amide
B=DCI-11 corrosion inhibitor
C=Petrolite Tolad 3222 corrosion inhibitor
D=Petrolite Tolad 3224 corrosion inhibitor
E=Petrolite Tolad 357 corrosion inhibitor
F=MidContinental MCC5011E corrosion inhibitor
G=MidContinental MCC5011EW corrosion inhibitor
H=CorrPro 654 corrosion inhibitor
I=Nalco 5403 corrosion inhibitor
J=ENDCOR FE 9730 corrosion inhibitor

Table II illustrates examples of how the corrosion inhibitors can be combined with one or more dispersant fuel additives, whereby the result will be reduction in or prevention of intake deposits in an engine combusting the E85 fuel.

Thus, in one embodiment herein is provided a fuel comprising ethanol, gasoline, one or more dispersant fuel additives, and a corrosion inhibitor selected from the group consisting of Octel DCI-11 corrosion inhibitor, Petrolite Tolad 3222 corrosion inhibitor, Petrolite Tolad 3224 corrosion inhibitor, Nalco 5403 corrosion inhibitor, ENDCOR FE-9730 corrosion inhibitor, MidContinental MCC5011E corrosion inhibitor, MidContinental MCC5011EW corrosion inhibitor, CorrPro 654 corrosion inhibitor, NALCO 5403 corrosion inhibitor, ENDCOR FE 9730 corrosion inhibitor, and Betz® ACN 13 corrosion inhibitor, or chemical equivalents thereof. In one embodiment, the fuel is an E85 gasoline-ethanol blend.

In one embodiment herein the ratio of corrosion inhibitor to dispersant fuel additive can be from about 1:20 to about 20:1. In another embodiment, the ratio of corrosion inhibitor to dispersant fuel additive can be from about 1:10 to about 10:1. In yet another embodiment the ratio of corrosion inhibitor to dispersant fuel additive can be from about 1:5 to about 5:1.

In yet another embodiment herein the minimum amount of corrosion inhibitor, such as DCI-11, is about 5 PTB and in another the amount is from about 10 PTB to about 30 PTB in the finished fuel. In addition, the fuel can in one embodiment contain from 30-60 PTB of the dispersant fuel additive.

Other embodiments of the present disclosure will be apparent to those skilled in the art from consideration of the specification and practice of the disclosure disclosed herein. As used throughout the specification and claims, “a” and/or “an” may refer to one or more than one. Unless otherwise indicated, all numbers expressing quantities of ingredients, properties such as molecular weight, percent, ratio, reaction conditions, and so forth used in the specification and claims are to be understood as being modified in all instances by the term “about.” Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. It is intended that the specification and examples be considered as exemplary only, with a true scope and spirit of the disclosure being indicated by the following claims.

What is claimed is:

1. A method for reducing deposit formation in an internal combustion engine combusting an alcohol-containing fuel composition comprising a corrosion inhibitor, said method comprising:
(a) combining the fuel with at least one dispersant fuel additive selected from the group consisting of a succinimide dispersant, a succinamide dispersant, an amide, a Mannich base dispersant, and a polyalkylene amine dispersant, and
(b) combusting the fuel and the at least one dispersant fuel additive in the engine,
wherein deposit formation is reduced relative to the deposit formation occurring when combusting the alcohol-containing fuel with a corrosion inhibitor but without the at least one dispersant fuel additive.

2. The method of claim 1, wherein the fuel further comprises gasoline.

3. The method of claim 1, wherein the alcohol is selected from the group consisting of methanol, ethanol, propanol, butanol, and mixtures of any combination thereof.

4. The method of claim 1, wherein the alcohol is ethanol.

5. The method of claim 4, wherein the ethanol content of the fuel composition is from about 10 wt. % to about 100 wt. %.

6. The method of claim 4, wherein the ethanol content of the fuel composition is from about 15 wt. % to about 85 wt. %.

7. The method of claim 4, wherein the ethanol content of the fuel composition is from about 74 wt. % to about 85 wt. %.

8. The method of claim 1, wherein the corrosion inhibitor comprises a dodecenyl succinic acid (DDSA).

9. The method of claim 1, wherein the corrosion inhibitor is selected from the group consisting of those materials having a structure NH₂(CH₂)ₙ—NH—(CH₂)ₘO—C₈₋₁₀ where n and m are independently 1 to about 10.

10. The method of claim 1, wherein the corrosion inhibitor is selected from the group consisting of those materials having a structure NH₂(CH₂)ₙ—NH—C₈₋₁₀ where n is 1 to about 10.

11. The method of claim 1, wherein the corrosion inhibitor comprises the result of combining a carboxylic acid or diacid and an amine, diamine or polyamine.

12. The method of claim 1, wherein the corrosion inhibitor has a molecular weight of less than 700 and is selected from the group consisting of monoamines, diamines, triamines, polyamines, etheramines, imines, imidazolines, thiadiazoles, monocarboxylic acids, dicarboxylic acids, p-phenylenediamine, dicyclohexylamine, alkyl substituted succinic anhydrides and acids, mixtures and reaction products thereof and salts thereof.

13. The method of claim 1, wherein the polyalkylene amine dispersant comprises a polyisobutylene amine dispersant.

14. The method of claim 1, wherein the method further comprises:
combining the fuel with at least one fuel additive selected from the group consisting of a phenolic; a hindered phenolic; a polyolefin amine; an aryl amine; a diphenyl amine; a monocarboxylic acid; a dicarboxylic acid; a polycarboxylic acid; an oxylated alkylphenolic resin; a formaldehyde polymer with 4-(1,1-dimethylethyl)phenol, a methyloxirane, and oxirane; an octane enhancer materials selected from the group consisting of tetraethyl lead, methylcyclopentadienyl manganese tricarbonyl, an azide, a peroxide, and an alkyl nitrates; a monoester, a diester, an ether, a ketone, a diether, a polyether, a glyme, a glycol, an oxirane, a C1-C8 aliphatic hydrocarbon, a butylene oxide, a propylene oxide, an ethylene oxide, an epoxide, a butane, a pentane, a xylene, a nitrous oxide, a nitromethane, a phenate, a salicylate, a sulfonate, a nonylphenol ethoxylate, a fuel-soluble alkali detergent, and an alkaline earth metal-containing detergent.

15. A composition to reduce deposit formation in an internal combustion engine combusting an alcohol-containing fuel, said composition comprising:
(a) a corrosion inhibitor,
(b) an alcohol, and
(c) at least one of a succinimide dispersant, a succinamide dispersant, an amide, a Mannich base dispersant, and a polyalkylene amine dispersant.

16. The composition of claim 15, wherein the corrosion inhibitor comprises a dodecenyl succinic acid (DDSA).

17. The composition of claim 15, wherein the alcohol is selected from the group consisting of methanol, ethanol, propanol, butanol, and mixtures of any combination thereof.

18. The composition of claim 15, wherein the alcohol is ethanol.

19. The composition of claim 18, wherein the ethanol content of the fuel composition is from about 10 wt. % to about 100 wt. %.

20. The composition of claim 18, wherein the ethanol content of the fuel composition is from about 15 wt. % to about 85 wt. %.

21. The composition of claim 18, wherein the ethanol content of the fuel composition is from about 74 wt. % to about 85 wt. %.

22. The composition of claim 15, wherein the polyalkylene amine dispersant comprises a polyisobutylene amine dispersant.

23. The composition of claim 15, wherein the fuel further comprises gasoline.

24. A fuel additive concentrate for gasoline engines combusting an alcohol-containing fuel containing a corrosion inhibitor, said concentrate comprising:
(a) one or more corrosion inhibitors,
(b) at least one of a succinimide dispersant, a succinamide dispersant, an amide, a Mannich base dispersant, and a polyalkylene amine dispersant, and
(c) a diluent selected from the group consisting of an oil, a fuel, a gasoline, an alcohol, solvent, a carrier fluid, and other liquid materials combustible in a gasoline engine.

25. A fuel additive concentrate comprising an alcohol and at least one of a succinimide dispersant; a succinamide dispersant; an amide; a Mannich base dispersant, and a polyalkylene amine dispersant.

26. The fuel additive of claim 25, wherein the alcohol is ethanol.

27. The fuel additive of claim 26, wherein the ethanol content of the fuel composition is from about 10 wt. % to about 100 wt. %.

28. The fuel additive of claim 26, wherein the ethanol content of the fuel composition is from about 15 wt. % to about 85 wt. %.

29. The fuel additive of claim 26, wherein the ethanol content of the fuel composition is from about 74 wt. % to about 85 wt. %.

30. The fuel additive of claim 25, wherein the polyalkylene amine dispersant comprises a polyisobutylene amine dispersant.

31. A fuel comprising:
(a) an alcohol,
(b) a gasoline,
(c) a fuel additive comprising at least one of a succinimide dispersant, a succinamide dispersant, an amide, a Mannich base dispersant, a polyalkylene amine dispersant, and a polyisobutylene amine dispersant, and
(d) a corrosion inhibitor selected from the group consisting of Innospec DCI-11 corrosion inhibitor, Petrolite Tolad 3222 corrosion inhibitor, Petrolite Tolad 3224 corrosion inhibitor, Nalco 5403 corrosion inhibitor, ENDCOR FE-9730 corrosion inhibitor, MidContinental MCC5011E corrosion inhibitor, MidContinental MCC5011EW corrosion inhibitor, CorrPro 654 corrosion inhibitor, NALCO 5403 corrosion inhibitor, ENDCOR FE 9730 corrosion inhibitor, and Betz® ACN 13 corrosion inhibitor, and a dodecenyl succinic acid corrosion inhibitor.

32. The fuel composition of claim 31, wherein the alcohol is ethanol.

33. The fuel composition of claim 32, wherein the ethanol content of the fuel composition is from about 10 wt. % to about 100 wt. %.

34. The fuel composition of claim 32, wherein the ethanol content of the fuel composition is from about 15 wt. % to about 85 wt. %.

35. The fuel composition of claim 32, wherein the ethanol content of the fuel composition is from about 74 wt. % to about 85 wt. %.

36. The fuel composition of claim 31, wherein the DCI-11 corrosion inhibitor comprises the reaction product of an organic acid and an amine or a diamine.

37. The fuel composition of claim 31, wherein the DCI-11 corrosion inhibitor comprises the structure NH₂(CH₂)ₙ—NH—C₈₋₁₀ where n is 1 to about 10.

38. The fuel composition of claim 31, wherein the Petrolite Tolad 3222 corrosion inhibitor and the Petrolite Tolad 3224 corrosion inhibitor each independently comprise the structure NH₂(CH₂)ₙ—NH—(CH₂)ₘO—C₈₋₁₀ where n and m are independently 1 to about 10.

39. The fuel of claim 31, wherein the polyalkylene amine dispersant comprises a polyisobutylene amine dispersant.

40. A method for reducing deposit formation in an internal combustion engine combusting an alcohol-containing fuel composition, said method comprising:
(a) combining the fuel with a dodecenyl succinic acid corrosion inhibitor, and
(b) combusting the fuel and the dodecenyl succinic acid corrosion inhibitor in the engine,
wherein deposit formation is reduced relative to the deposit formation occurring when combusting the alcohol-containing fuel with a corrosion inhibitor substantially free of a dodecenyl succinic acid corrosion inhibitor.

41. The method of claim 40, wherein the fuel further comprises gasoline.

42. The method of claim 40, wherein the alcohol is selected from the group consisting of methanol, ethanol, propanol, butanol, and mixtures of any combination thereof.

43. The method of claim 40, wherein the alcohol is ethanol.

44. The method of claim 43, wherein the ethanol content of the fuel composition is from about 10 wt. % to about 100 wt. %.

45. The method of claim 43, wherein the ethanol content of the fuel composition is from about 15 wt. % to about 85 wt. %.

46. The method of claim 43, wherein the ethanol content of the fuel composition is from about 74 wt. % to about 85 wt. %.

47. The method of claim 40, wherein said method consists essentially of:
(a) combining the fuel with a dodecenyl succinic acid corrosion inhibitor, and
(b) combusting the fuel and the dodecenyl succinic acid corrosion inhibitor in the engine.

48. A composition to reduce deposit formation in an internal combustion engine combusting an alcohol-containing fuel, said composition comprising
(a) a dodecenyl succinic acid corrosion inhibitor, and
(b) an alcohol.

49. The composition of claim 48, wherein the alcohol is selected from the group consisting of methanol, ethanol, propanol, butanol, and mixtures of any combination thereof.

50. The composition of claim 48, wherein the alcohol is ethanol.

51. The composition of claim 48, wherein the fuel further comprises gasoline.

52. The composition of claim 48, wherein the composition consists essentially of (a) a dodecenyl succinic acid corrosion inhibitor, and (b) an alcohol.

53. A fuel additive concentrate comprising an alcohol and a dodecenyl succinic acid (DDSA) corrosion inhibitor.

54. A fuel comprising:
(a) one or more alcohols,
(b) a gasoline, and
(c) a dodecenyl succinic acid (DDSA) corrosion inhibitor.

55. The fuel of claim 54, wherein the one or more alcohols comprise(s) ethanol.

56. The fuel of claim 55, wherein the ethanol content of the fuel composition is from about 10 wt. % to about 100 wt. %.

57. The fuel of claim 55, wherein the ethanol content of the fuel composition is from about 15 wt. % to about 85 wt. %.

58. The fuel of claim 55, wherein the ethanol content of the fuel composition is from about 74 wt. % to about 85 wt. %.
